(19) United States
(12) Patent Application Publication
(10) Pub. No.: US 2011/0267286 A1
(43) Pub. Date: Nov. 3, 2011

(54) TOUCH PANEL

(75) Inventor: Jane HSU, Taoyuan County (TW)

(73) Assignee: DerLead Investment Ltd., Taipei (TW)

(21) Appl. No.: 12/905,224

(22) Filed: Oct. 15, 2010

(30) Foreign Application Priority Data
Apr. 28, 2010 (TW) 099207706

(51) Int. Cl. G06F 3/041

(52) U.S. Cl. 345/173

(57) ABSTRACT

A touch panel has a pattern layer which designates positions of sensing areas respectively activating specific functions after being pressed, and is mounted on a top surface or a bottom surface of a lower substrate. As the substrates and sensing units mounted on the substrates are all transparent, the pattern layer can be visible when seen from the top surface of the touch panel. When the position of the pattern layer is pressed by a finger, the sensitivity upon pressing the pattern layer can be enhanced, since the pattern layer does not get in the way between the finger and the sensing unit.

### BACKGROUND OF THE INVENTION

1. Field of the Invention

The present invention relates to a touch panel, and more particularly to a touch panel having a pattern layer, which designates positions of sensing areas respectively activating specific functions after being pressed and is mounted on a top surface or a bottom surface of a lower substrate, so as to remove obstruction between the sensing areas and a pressing object and enhance sensitivity of touch control.

2. Description of the Related Art

Touch panels can be classified into many types based on various technical theories. Among them, the ones using conducting film to sense voltage or capacitance variation prevail. With reference to FIG. 9, a conventional single-substrate surface capacitive touch panel has a substrate 60 and a top layer 70. The substrate 60 has a conductive layer 61 mounted under the top layer 70 and is made from indium tin oxide (ITO). When a point on a touch area of the top layer 70 is touched by a finger, capacitive variation occurs at a place of the conductive layer 61 corresponding to the touched point. A signal of the variation is outputted to a controller through wires (not shown) connected with the conductive layer 61 for calculation of coordinates of the touched point.

With reference to FIG. 10, an ink layer 71 and a pattern layer 72 are printed on the bottom of the top layer 70. An area not occupied by the ink layer 71 and the pattern layer 72 is a touch zone. The ink layer 71 serves to mask nontransparent wires, and the pattern layer 72 serves to indicate specific positions on the conducting layer 61. When each specific position is touched, the controller computes to acquire the specific position and outputs a corresponding command to other elements to perform specific function.

However, the pattern layers 72 in touch panels fabricated with current technologies are mounted on a top side of the conducting layer 61, meaning that when touching such type of touch panels, a finger must contact the conducting layer 61 through the pattern layer 72. As a result, the capacitive variation generated when the finger touches a position of the top layer 70 corresponding to the pattern layer 72 is less than that generated when the finger touches a position of the top layer 70 corresponding to a touch zone, and the touch corresponding to the pattern layer 72 is less sensitive.

Moreover, the pattern layer 72 and the ink layer 71 are usually printed with different colors and the pattern layer 72 contains patterns dedicated to denote positions from which specific functions can be respectively activated. Due to customization demand, the pattern layer 72 is usually printed after the printing of the ink layer 71, and the printing of the ink layer 71 and the pattern layer 72 takes multiple printing processes to be completed. In case of any printing error, the whole top layer 70 is defective and must be discarded. As a consequence, the production cost of the conventional touch panel is inevitably escalated.

### SUMMARY OF THE INVENTION

An objective of the present invention is to provide a touch panel having a pattern layer which designates positions of sensing areas respectively activating specific functions after being pressed and is mounted on a top surface or a bottom surface of a lower substrate to remove obstruction between the sensing areas and a pressing object and enhance sensitivity of touch control.

To achieve the foregoing objective, when a single-substrate touch panel is provided, the touch panel has a substrate, at least one pattern layer and a sensing unit.

The substrate is transparent and has a top surface and a bottom surface. The at least one pattern layer is mounted on at least one side portion of a surface of the substrate. The sensing unit is transparent and is mounted on the surface of the substrate and overlapped on the pattern layer.

To achieve the foregoing objective, when a double-substrate touch panel is provided, the touch panel has a lower substrate, a separation layer and an upper substrate.

The lower substrate is transparent and has a top surface, a bottom surface and at least one pattern layer and a lower sensing unit. The at least one pattern layer is formed on at least one side portion of a surface of the lower substrate. The lower sensing unit is transparent and is mounted on the surface of the lower substrate.

The separation layer is formed on the surface of the lower substrate and has a top surface.

The upper substrate is transparent, is formed on the top surface of the separation layer, and has a bottom surface and an upper sensing unit. The upper sensing unit is transparent and is formed on the bottom surface of the upper substrate.

At least one of the upper sensing unit and the lower sensing unit is covered on the pattern layer.

Because the pattern layer can be mounted on the top surface or the bottom surface of the substrate under the sensing unit and the substrate and sensing unit are all made of transparent materials, the pattern layer is visible when seen from the top surface of the touch panel. Besides, the pattern layer does not get in the way between a finger and the sensing unit when the finger touches a touch area of the touch panel corresponding to the pattern layer. Accordingly, the sensitivity upon touching is enhanced. Since the pattern layer and the ink layer are separately located on different layers of the substrate, it is unnecessary for the ink layer to be mounted again for mistakes committed such as location deviation and incorrect color upon mounting the pattern layer, and the resulting production cost loss can be relatively mitigated.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a single-substrate surface capacitive touch panel in accordance with the present invention;

FIG. 2 is a side view in partial section of the surface capacitive touch panel in FIG. 1 with the pattern layer mounted on a bottom surface of a substrate;

FIG. 3 is another side view in partial section of the surface capacitive touch panel in FIG. 1 with the pattern layer mounted on a top surface of a substrate;

FIG. 4 is an exploded perspective view of a single-substrate projected capacitive touch panel in accordance with the present invention;

FIG. 5 is an exploded perspective view of a double-substrate surface capacitive touch panel in accordance with the present invention;

FIG. 6 is an exploded perspective view of a double-substrate projected capacitive touch panel in accordance with the present invention;

FIG. 7 is an exploded perspective view of a double-substrate matrix capacitive touch panel in accordance with the present invention;

FIG. 8 is an exploded perspective view of a double-substrate resistive touch panel in accordance with the present utility model;

FIG. 9 is an side view in partial section of a conventional surface capacitive touch panel; and

FIG. 10 is a top view of the surface capacitive touch panel in FIG. 9.

### DETAILED DESCRIPTION OF THE INVENTION

The present invention is characterized by a pattern layer mounted on at least one of a top surface and a bottom surface of a substrate. Such characteristic can be applied to touch panels developed by different technologies, such as single-substrate capacitive touch panels and single-substrate projected capacitive touch panels, double-substrate projected capacitive touch panels, double-substrate matrix capacitive touch panels and double-substrate resistive touch panels described in the following embodiments.

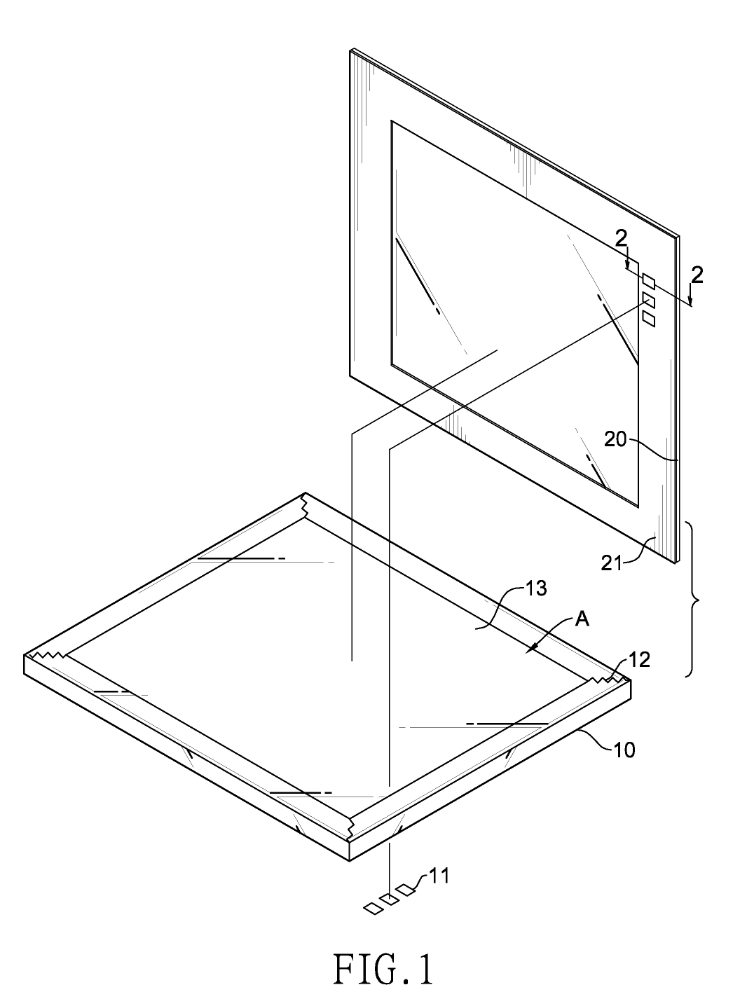

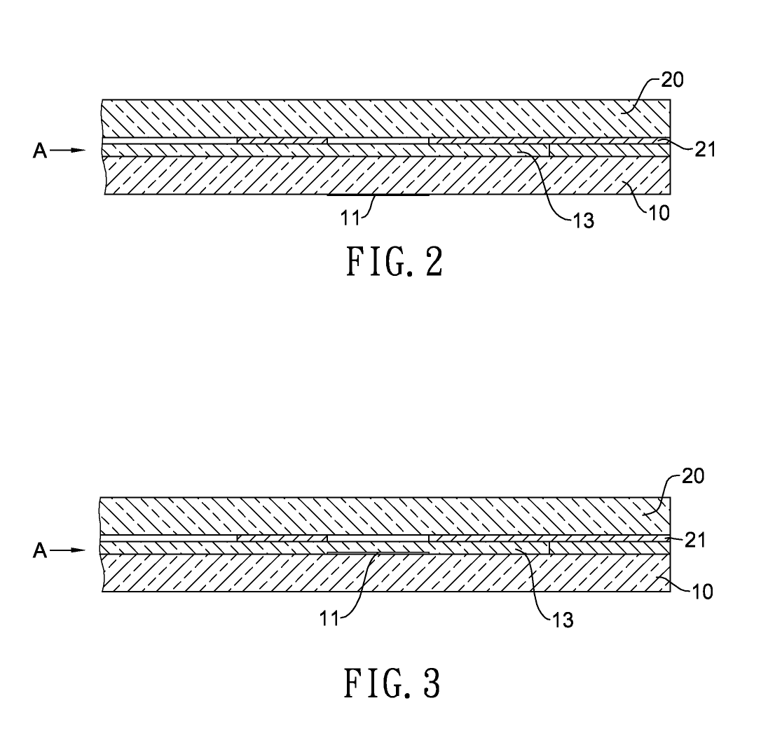

With reference to FIG. 1, a single-substrate surface capacitive touch panel in accordance with the present invention has a substrate 10 and a top panel 20. The substrate 10 is transparent and has at least one pattern layer 11, a sensing unit (A) and four wires 12. With reference to FIG. 2, a pattern layer 11 is mounted on a side portion of a bottom surface of the substrate 10. With reference to FIG. 3, the pattern layer 11 is mounted on a side portion of a top surface of the substrate 10. The sensing unit (A) is transparent and is mounted on the top surface of the substrate 10 and is overlapped on the pattern layer 11. In FIGS. 2 and 3, the sensing unit (A) is a rectangular conducting layer 13 and is made from ITO. One end of each wire 12 is connected to one of the corners of the conducting layer 13, and the other end extends toward one of the corners of the substrate 10.

The top panel 20 is mounted on the sensing unit (A) and has an ink layer 21. The ink layer 21 is nontransparent, is mounted on either one of a top surface or a bottom surface of the top panel 20, and is correspondingly covered on the wires 12. In the present embodiment, the ink layer is frame-shaped and is mounted on the bottom surface of the top panel 20. Besides, one portion of the ink layer 21 corresponding to each one of the at least one pattern layer 11 is hollowed out.

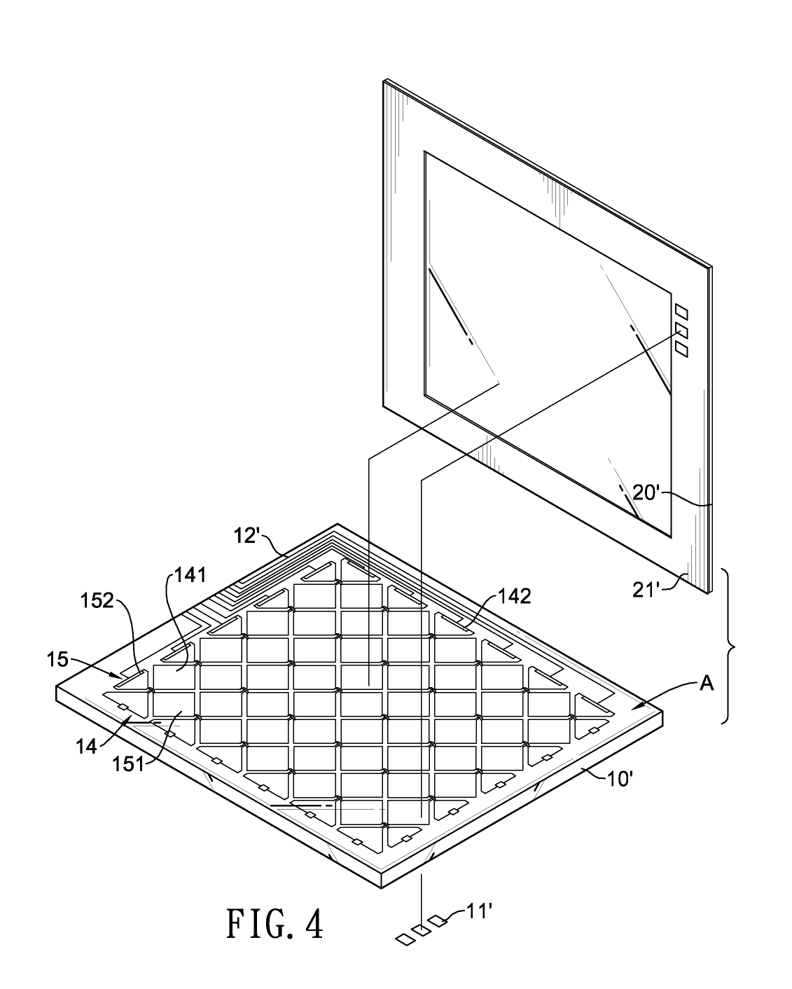

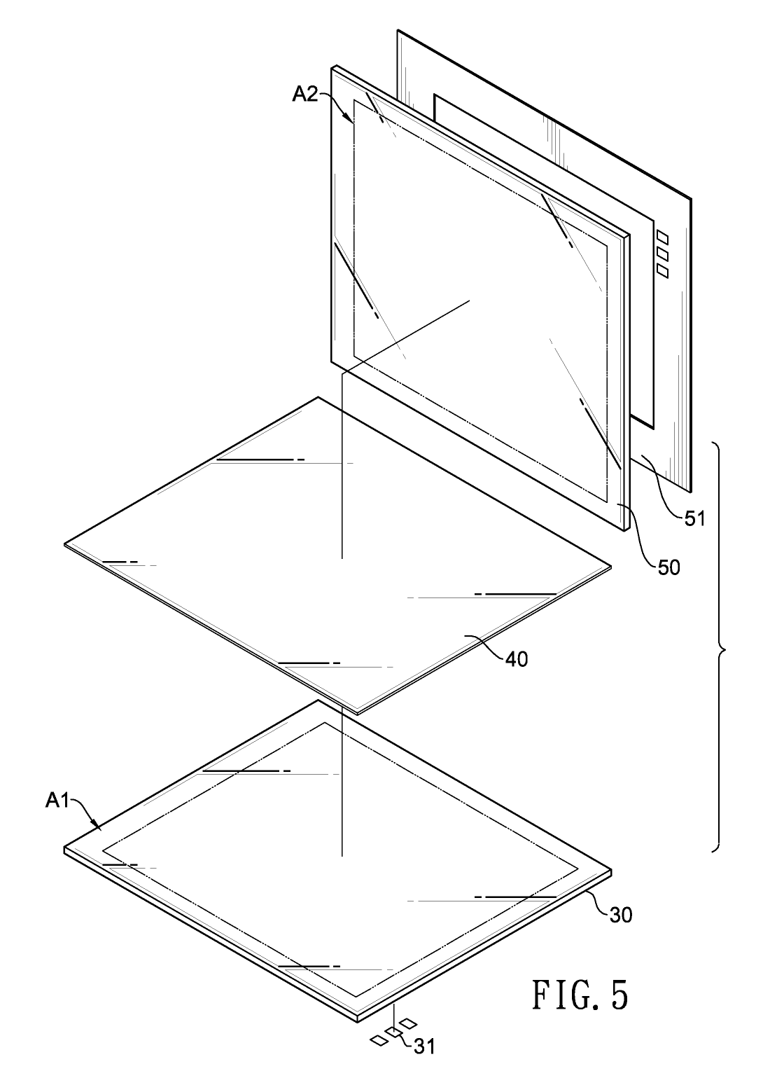

With reference to FIG. 4, a single-substrate projected capacitive touch panel in accordance with the present invention is shown. A substrate 10′, a pattern layer 11′, a top panel 20′ and a ink layer 21′ provided by the present embodiment is common to those of the foregoing surface capacitive touch panel, except that the sensing unit (A) differs from that in the foregoing surface capacitive touch panel. In the present embodiment, the sensing unit (A) has a plurality of first conducting layers 14 and a plurality of second conducting layers 15 that crossly align with each other. The first conducting layers 14 parallelly align in a first direction. Each first conducting layer 14 has a plurality of first sensing areas 141 and a first port 142. The first sensing areas 141 are serially connected and formed by ITO. The first port 142 of each first conducting layer 14 is formed on an edge of an outermost first sensing area 141 of the first conducting layer 14 in the first direction, and is formed by a conductive material. The second conducting layers 15 are formed on an unfilled space defined by the first conducting layers 14 and parallelly align in a second direction that is perpendicular to the first direction. Each second conducting layer 15 has a plurality of second sensing areas 151 and a second port 152. The second sensing areas 151 are serially connected and formed by ITO. The second port 152 of each second conducting layer 15 is formed on an edge of an outermost second sensing area 151 of the second conducting layer 15 in the second direction, and is formed by a conductive material. The substrate 10′ further has a plurality of wires 12′. The wires 12′ are formed on the top surface of the substrate 10′. A count of the wires 12′ corresponds to that of the first ports 142 and the second ports 152 on the first conducting layer 14 and the second conducting layer 15. One end of each wire 12′ is connected to one of the first ports 142 and the second ports 152.

With reference to FIG. 5, a double-substrate touch panel, regardless of a resistive touch panel, a projected capacitive touch panel or a matrix capacitive touch panel, has a lower substrate 30, a separation layer 40 and an upper substrate 50.

The lower substrate 30 is transparent and has at least one pattern layer 31 and a lower sensing unit (A1). The at least one pattern layer 31 is formed on a side portion of a top surface or a bottom surface of the lower substrate 30. In FIG. 5, the pattern layer 31 is mounted on the bottom surface of the lower substrate 30. The lower sensing unit (A1) is transparent and is mounted on the top surface of the lower substrate 30. The separation layer 40 is formed on the top surface of the lower substrate 30. The upper substrate 50 is transparent, is formed on a top surface of the separation layer 40, and has an upper sensing unit (A2) and an ink layer 51. The upper sensing unit (A2) or the lower sensing unit (A1) is transparent, is formed on the bottom surface of the upper substrate 50, and is covered on the pattern layer 31. The ink layer 51 is mounted on a top surface of the upper substrate 50 or between the upper substrate 50 and the upper sensing unit (A2). In FIG. 5, the ink layer 51 is mounted on the top surface of the upper substrate 50 and corresponds to a portion of the lower substrate 30 having no pattern layer 31.

The difference of resistive touch panels, projected capacitive touch panels and matrix capacitive touch panels lies in the upper sensing unit (A2), the lower sensing unit (A1) and the separation layer 40.

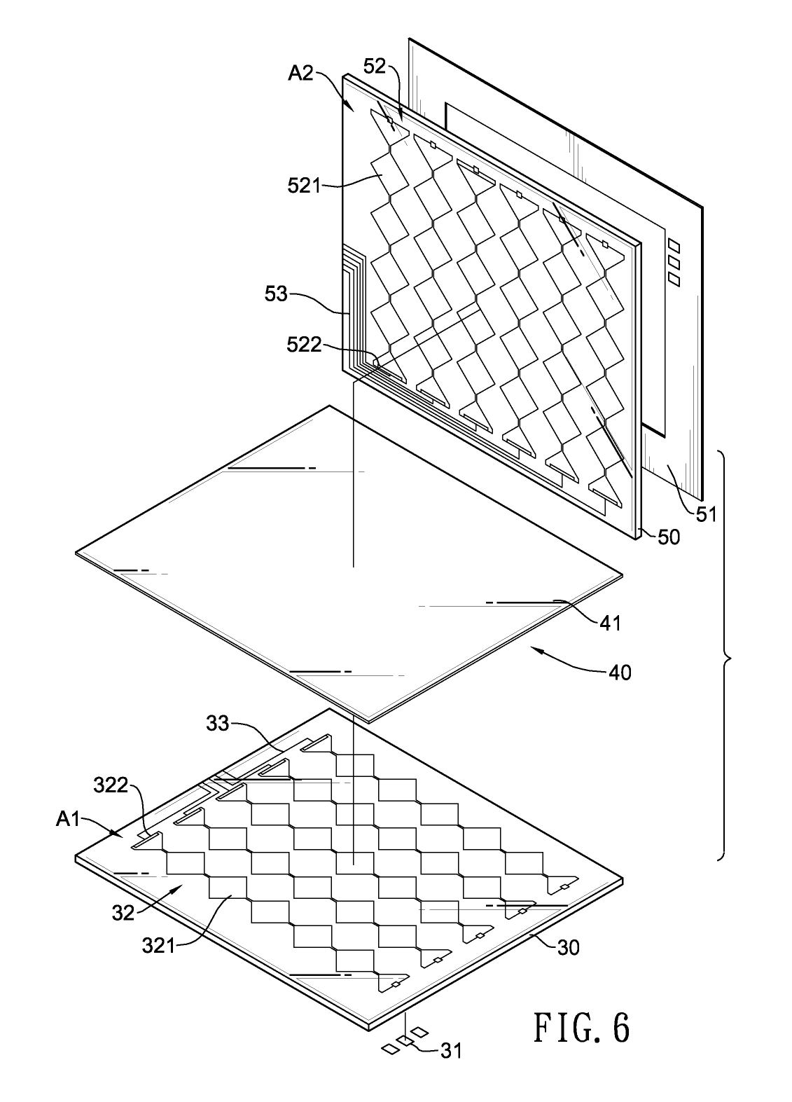

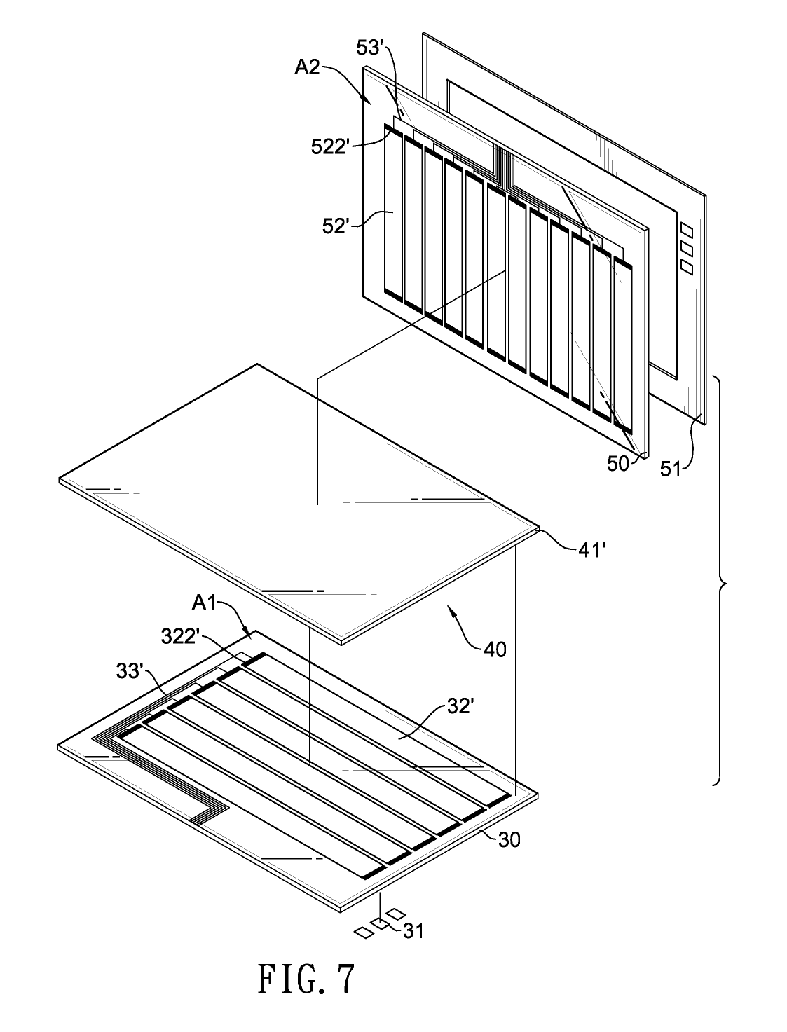

With reference to FIG. 6, a double-substrate projected capacitive touch panel in accordance with the present invention is shown.

The lower sensing unit (A1) has a plurality of lower conducting layers 32 parallelly aligning in a first direction. Each lower conducting layer 32 has a plurality of sensing areas 321 and a lower port 322. The sensing areas 321 are serially connected and formed by ITO. The lower port 322 of each lower conducting layer 32 is formed on an edge of an outermost sensing area 321 of the lower conducting layer 32 in the first direction, and is formed by a conductive material. The upper sensing unit (A1) is formed on an unfilled space defined by the lower conducting layers 32 on the top surface of the lower substrate 30, and has a plurality of upper conducting layers 52 parallelly aligning in a second direction that is perpendicular to the first direction. Each upper conducting layer 52 has a plurality of sensing areas 521 and an upper port 522. The sensing areas 521 are serially connected and formed by ITO. The upper port 552 of each upper conducting layer 52 is formed on an edge of an outermost sensing area 521 of the upper conducting layer 52 in the second direction, and is formed by a conductive material.

The lower substrate 30 further has a plurality of lower wires 33. The lower wires 33 are formed on the top surface of the lower substrate 30. A count of the lower wires 33 corresponds to that of the lower ports 322 on the lower conducting layer 32. One end of each wire 33 is connected to one of the lower ports 322.

The upper substrate 50 further has a plurality of lower wires 53. The upper wires 53 are formed on the bottom surface of the upper substrate 50. A count of the upper wires 53 corresponds to that of the upper ports 522 on the upper conducting layer 52. One end of each upper wire 53 is connected to one of the upper ports 522.

With reference to FIG. 7, a double-substrate matrix capacitive touch panel in accordance with the present invention is shown.

The lower sensing unit (A1) has a plurality of juxtaposed lower conducting layers 32′. The lower conducting layers 32′ are rectangular, align in a first direction, and are formed by ITO. Each lower conducting layer 32′ has a lower port 322′. The lower port 322′ is formed on one side of the corresponding lower conducting layer 32′ that is perpendicular to the first direction and is made from a conductive material. The separation layer 40 is mounted between the upper substrate 50 and the lower substrate 30, is transparent and is made of an insulating adhesive.

The upper sensing unit (A2) has a plurality of juxtaposed upper conducting layers 52′. The upper conducting layers 52′ are rectangular, align in a second direction that is perpendicular to the first direction, are formed by ITO, and are intersected with the lower conducting layers 32′ in the form of columns and rows of a matrix. Each upper conducting layer 52′ has an upper port 522′. The upper port 522′ is formed on one side of the corresponding upper conducting layer 52′ that is perpendicular to the second direction and is made of a conductive material.

The lower substrate 30 further has a plurality of lower wires 33′. The lower wires 33′ are formed on the top surface of the lower substrate 30. A count of the lower wires 33′ corresponds to that of the lower ports 322′. One end of each lower wire 33′ is connected to one of the lower ports 322′.

The upper substrate 50 further has a plurality of lower wires 53′. The upper wires 53′ are formed on the bottom surface of the upper substrate 50. A count of the upper wires 53′ corresponds to that of the upper ports 522′. One end of each upper wire 53′ is connected to one of the upper ports 522′.

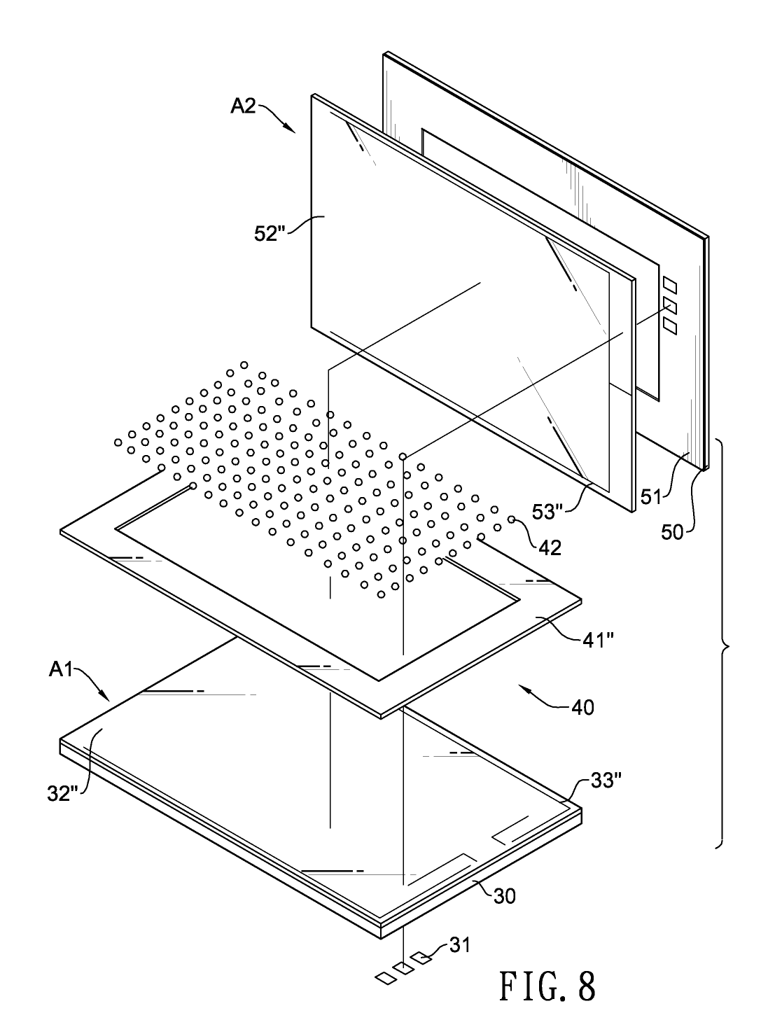

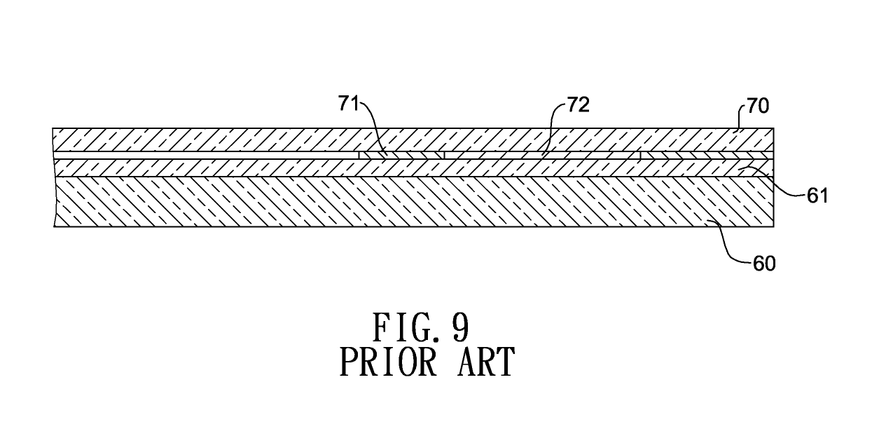

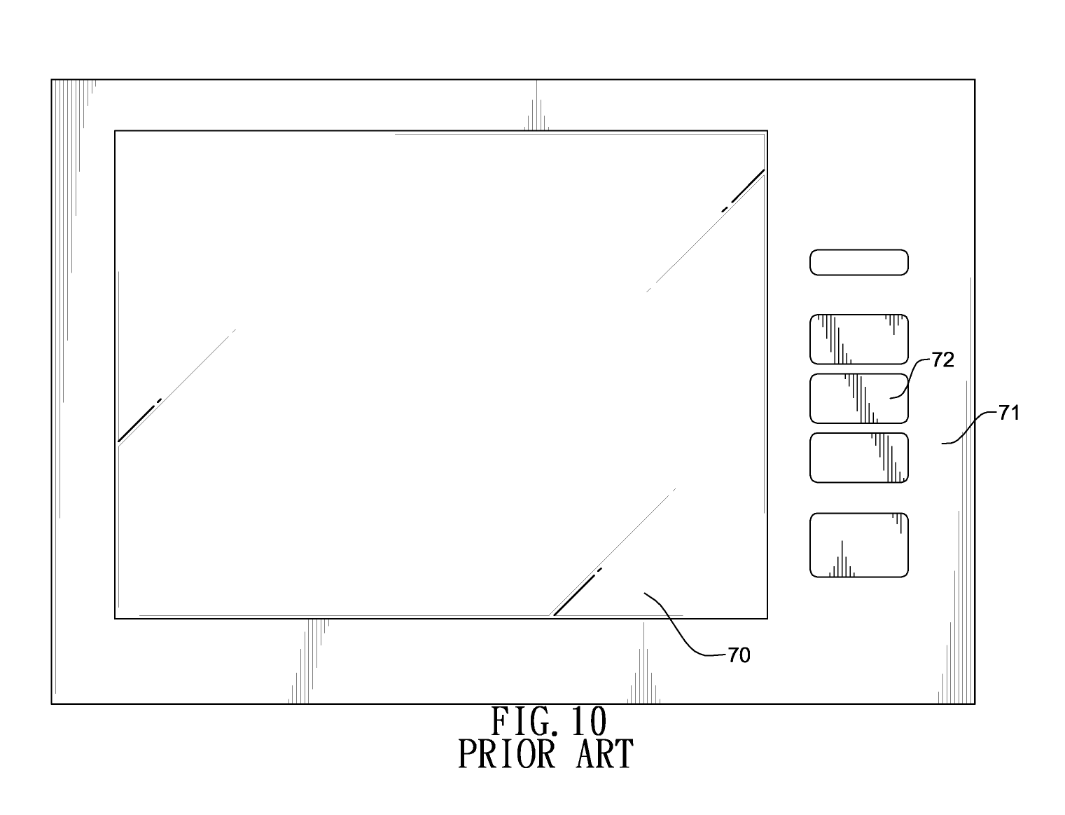

With reference to FIG. 8, a double-substrate resistive touch panel in accordance with the present invention is shown.

The lower sensing unit (A1) has a lower conducting layer 32″ made from ITO. The lower conducting layer 32″ has at least one lower wire 33″ mounted on the lower conducting layer 32″. In FIG. 8, the double-substrate resistive touch panel is a 5-wire resistive touch panel, and four lower wires 33″ are mounted on the top surface of the lower conducting layer 32″.

The upper sensing unit (A2) has an upper conducting layer 52″ made from ITO. The upper conducting layer 52″ has at least one upper wire 53″ mounted on the upper conducting layer 52″. In FIG. 8, one upper wire 53″ is mounted on the bottom surface of the upper conducting layer 52″.

The separation layer has an insulating layer 41″ and a spacer layer 42. The insulating layer 41″ is frame-shaped, and is covered on the lower wires 33″ and the upper wire 53″ but not on the pattern layer 31. The spacer layer 42 is mounted within the insulating layer 41″.

From the foregoing embodiments, the pattern layer 31 is mounted on a side portion of the top surface or the bottom surface of the substrate 10 or the lower substrate 30. As the substrate 10, the lower substrate 30, the upper substrate 50, the sensing unit (A), the lower sensing unit (A1) and the upper sensing unit (A2) are made of transparent materials, the pattern layer 31 can be visible when seen from the top surface of the touch panel. When the touch panel is pressed by a finger, the pattern layer is not present between the finger and the sensing unit (A) or the upper sensing unit (A1). Accordingly, the sensitivity issue of the presence of the pattern layer in the conventional touch panels is overcome. Moreover, because the pattern layer 31 and the ink layer 51 are respectively mounted on different layers of the substrate, it is unnecessary for the ink layer 51 to be replaced even if the pattern layer 31 is off the intended position or is printed with the wrong color, and the resulting cost loss can be reduced.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A touch panel, comprising:
a substrate being transparent and having:
at least one pattern layer mounted on at least one side portion of a surface of the substrate; and
a sensing unit being transparent and mounted on the substrate and overlapped on the pattern layer.

2. The touch panel as claimed in claim 1, wherein the substrate further has a top surface and a bottom surface, and the at least one pattern layer is mounted on the top surface.

3. The touch panel as claimed in claim 1, wherein the substrate further has a top surface and a bottom surface, and the at least one pattern layer is mounted on the bottom surface.

4. The touch panel as claimed in claim 1 further comprising a top panel mounted on the sensing unit and having:
a top surface;
a bottom surface; and
an ink layer mounted on the top surface of the top panel, wherein one portion of the ink layer corresponding to each one of the at least one pattern layer is hollowed out.

5. The touch panel as claimed in claim 1 further comprising a top panel mounted on the sensing unit and having:
a top surface;
a bottom surface; and
an ink layer mounted on the bottom surface of the top panel, wherein one portion of the ink layer corresponding to each one of the at least one pattern layer is hollowed out.

6. The touch panel as claimed in claim 2, wherein
the sensing unit is a rectangular conducting layer; and
the substrate further has four wires, one end of each wire connected to one of the corners of the sensing unit.

7. The touch panel as claimed in claim 3, wherein
the sensing unit is a rectangular conducting layer; and
the substrate further has four wires, one end of each wire connected to one of the corners of the sensing unit.

8. The touch panel as claimed in claim 2, wherein the sensing unit has:
a plurality of first conducting layers parallelly aligning in a first direction, each first conducting layer having:
a plurality of first sensing areas serially connected; and
a first port formed on an edge of an outermost first sensing area of the first conducting layer in the first direction;
a plurality of first wires formed on the top surface of the substrate, wherein a count of the first wires corresponds to that of the first ports on the first conducting layer, and one end of each first wire is connected to one of the first ports;
a plurality of second conducting layers formed on an unfilled space defined by the first conducting layers on the top surface of the substrate, parallelly aligning in a second direction that is perpendicular to the first direction, each second conducting layer having:
a plurality of second sensing areas serially connected;
a second port formed on an edge of an outermost second sensing area of the second conducting layer in the second direction; and
a plurality of second wires formed on the top surface of the substrate, wherein a count of the second wires corresponds to that of the second ports on the second conducting layer, and one end of each second wire is connected to one of the second ports.

9. The touch panel as claimed in claim 3, wherein the sensing unit has:
a plurality of first conducting layers parallelly aligning in a first direction, each first conducting layer having:
a plurality of first sensing areas serially connected; and
a first port formed on an edge of an outermost first sensing area of the first conducting layer in the first direction;
a plurality of first wires formed on the top surface of the substrate, wherein a count of the first wires corresponds to that of the first ports on the first conducting layer, and one end of each first wire is connected to one of the first ports;
a plurality of second conducting layers formed on an unfilled space defined by the first conducting layers on the top surface of the substrate, parallelly aligning in a second direction that is perpendicular to the first direction, each second conducting layer having:
a plurality of second sensing areas serially connected;
a second port formed on an edge of an outermost second sensing area of the second conducting layer in the second direction; and
a plurality of second wires formed on the top surface of the substrate, wherein a count of the second wires corresponds to that of the second ports on the second conducting layer, and one end of each second wire is connected to one of the second ports.

10. A touch panel, comprising:
a lower substrate being transparent and having:
at least one pattern layer formed on at least one side portion of a surface of the lower substrate; and
a lower sensing unit being transparent and mounted on the surface of the lower substrate;
a separation layer formed on the top surface of the lower substrate and having a top surface; and
an upper substrate being transparent, formed on the top surface of the separation layer, and having:
a bottom surface; and
an upper sensing unit being transparent and formed on the bottom surface of the upper substrate;
wherein at least one of the upper sensing unit and the lower sensing unit is covered on the pattern layer.

11. The touch panel as claimed in claim 10, wherein the lower substrate further has a top surface and a bottom surface, and the at least one pattern layer is mounted on the top surface.

12. The touch panel as claimed in claim 10, wherein the lower substrate further has a top surface and a bottom surface, and the at least one pattern layer is mounted on the bottom surface.

13. The touch panel as claimed in claim 10, wherein the upper substrate further has an ink layer mounted between the upper substrate and the upper sensing unit and corresponding to a portion of the lower substrate having no pattern layer.

14. The touch panel as claimed in claim 10, wherein the upper substrate further has an ink layer mounted on a top surface of the upper substrate and corresponding to a portion of the lower substrate having no the-pattern layer.

15. The touch panel as claimed in claim 11, wherein
the lower sensing unit has a plurality of lower conducting layers parallelly aligning in a first direction, and each lower conducting layer has:
a plurality of lower sensing areas serially connected;
a lower port formed on an edge of an outermost lower sensing area of the lower conducting layer in the first direction; and
a plurality of lower wires formed on the top surface of the lower substrate, wherein a count of the lower wires corresponds to that of the lower ports on the lower conducting layer, and one end of each lower wire is connected to one of the lower ports;
the separation layer is transparent and made of an insulating adhesive; and
the upper sensing unit is formed on an unfilled space defined by the lower conducting layers on the top surface of the lower substrate, has a plurality of upper conducting layers parallelly aligning in a second direction that is perpendicular to the first direction, and each upper conducting layer has:
a plurality of upper sensing areas serially connected;
an upper port formed on an edge of an outermost upper sensing area of the upper conducting layer in the second direction; and
a plurality of upper wires formed on the bottom surface of the upper substrate, wherein a count of the upper wires corresponds to that of the upper ports on the upper conducting layer, and one end of each upper wire is connected to one of the upper ports.

16. The touch panel as claimed in claim 12, wherein
the lower sensing unit has a plurality of lower conducting layers parallelly aligning in a first direction, and each lower conducting layer has:
a plurality of lower sensing areas serially connected;
a lower port formed on an edge of an outermost lower sensing area of the lower conducting layer in the first direction; and
a plurality of lower wires formed on the top surface of the lower substrate, wherein a count of the lower wires corresponds to that of the lower ports on the lower conducting layer, and one end of each lower wire is connected to one of the lower ports;
the separation layer is transparent and made of an insulating adhesive; and
the upper sensing unit is formed on an unfilled space defined by the lower conducting layers on the top surface of the lower substrate, has a plurality of upper conducting layers parallelly aligning in a second direction that is perpendicular to the first direction, and each upper conducting layer has:
a plurality of upper sensing areas serially connected;
an upper port formed on an edge of an outermost upper sensing area of the upper conducting layer in the second direction; and
a plurality of upper wires formed on the bottom surface of the upper substrate, wherein a count of the upper wires corresponds to that of the upper ports on the upper conducting layer, and one end of each upper wire is connected to one of the upper ports.

17. The touch panel as claimed in claim 11, wherein
the lower sensing unit has a plurality of juxtaposed lower conducting layers being rectangular and aligning in a first direction, and each lower conducting layer has:
a lower port formed on one side of the lower conducting layer that is perpendicular to the first direction; and
a plurality of lower wires formed on the top surface of the lower substrate, wherein a count of the lower wires corresponds to that of the lower ports, and one end of each lower wire is connected to one of the lower ports;
the separation layer is transparent and is made of an insulating adhesive; and
the upper sensing unit has a plurality of juxtaposed upper conducting layers being rectangular, aligning in a second direction that is perpendicular to the first direction, and intersected with the lower conducting layers in the form of columns and rows of a matrix, and each upper conducting layer has:
an upper port formed on one side of the upper conducting layer that is perpendicular to the second direction; and
a plurality of upper wires formed on the bottom surface of the upper substrate, wherein a count of the upper wires corresponds to that of the upper ports, and one end of each upper wire is connected to one of the upper ports.

18. The touch panel as claimed in claim 12, wherein
the lower sensing unit has a plurality of juxtaposed lower conducting layers being rectangular and aligning in a first direction, and each lower conducting layer has:
a lower port formed on one side of the lower conducting layer that is perpendicular to the first direction; and
a plurality of lower wires formed on the top surface of the lower substrate, wherein a count of the lower wires corresponds to that of the lower ports, and one end of each lower wire is connected to one of the lower ports;
the separation layer is transparent and is made of an insulating adhesive; and
the upper sensing unit has a plurality of juxtaposed upper conducting layers being rectangular, aligning in a second direction that is perpendicular to the first direction, and intersected with the lower conducting layers in a form of columns and rows of a matrix, and each upper conducting layer has:
an upper port formed on one side of the upper conducting layer that is perpendicular to the second direction; and
a plurality of upper wires formed on the bottom surface of the upper substrate, wherein a count of the upper wires corresponds to that of the upper ports, and one end of each upper wire is connected to one of the upper ports.

19. The touch panel as claimed in claim 11, wherein
the lower sensing unit has a lower conducting layer having at least one lower wire mounted on the lower conducting layer;
the upper sensing unit has an upper conducting layer having at least one upper wire mounted on the upper conducting layer;
the separation layer has:
an insulating layer being frame-shaped, and covered on the lower wires and the upper wire but not on the pattern layer; and
a spacer layer mounted within the insulating layer.

20. The touch panel as claimed in claim 12, wherein
the lower sensing unit has a lower conducting layer having at least one lower wire mounted on the lower conducting layer;
the upper sensing unit has an upper conducting layer having at least one upper wire mounted on the upper conducting layer;
the separation layer has:
an insulating layer being frame-shaped, and covered on the lower wires and the upper wire but not on the pattern layer; and
a spacer layer mounted within the insulating layer.
